(19) United States
(12) Patent Application Publication
(10) Pub. No.: US 2013/0313847 A1
(43) Pub. Date: Nov. 28, 2013

(54) Content Extraction Device

(71) Applicant: Wendy Tortatice, Rochester, NY (US)

(72) Inventor: Wendy Tortatice, Rochester, NY (US)

(21) Appl. No.: 13/857,358

(22) Filed: Apr. 5, 2013

Related U.S. Application Data
(60) Provisional application No. 61/650,603, filed on May 23, 2012.

(51) Int. Cl. B25J 11/00

(52) U.S. Cl. CPC B25J 11/00
USPC 294/209

(57) ABSTRACT

A content extraction device useful for removing or extracting the remaining contents of a partially empty container such as a bottle, or tube so that the remaining contents are not wasted. In a preferred embodiment of the present invention, the content extraction device is comprised of an elongated body portion and a plurality of head portions of varying shape and size that may be removably attached to one or both ends of the elongated body portion and used to remove the remaining contents of a package, such as a tube, bottle or the like.

### CROSS-REFERENCE

This application claims priority from Provisional Patent Application Ser. No. 61/650,603 filed on May 23, 2012.

### FIELD OF THE INVENTION

This invention relates to an elongated spatula device for extracting the remaining contents of a bottle or tube.

### BACKGROUND

Many products, such as lotions, toothpaste, make-up, hair products, cleansers and the like, are packaged and sold in glass or plastic bottles or tubes that require a user to squeeze or shake the contents out of the same. However, when the contents begin to run low, it becomes more and more difficult for the user to shake or squeeze the remaining contents out of the container. This is particularly true for containers with thicker or less fluid products such as moisturizers, creams and the like. For example, it may be difficult for a woman to remove the remaining contents from a make-up tube or bottle due to the viscosity or composition of the same.

As a result, many users end up discarding the packaging with a fair amount of unused products still contained therein, which is not only frustrating and wasteful, but also expensive as the user must then purchase a new container of the product. Other users will attempt to cut open a partially utilized container with a knife or scissors to extract the remaining contents thereof, but this can be ineffective and dangerous and result in injury to the user.

Consequently, there is a long felt need in the art for a spatula like device that can be inserted into a relatively narrow opening of a bottle or tube to extract the remaining contents thereof. There is also a long felt need for a spatula device comprised of a body portion and a detachable head portion so that heads portions of varying shape and size may be removably attached to body portion to suit user need and/or a particular application. Finally, there is a long felt need for a spatula device that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a content extraction device for removing or extracting the remaining contents of a partially empty container such as a bottle, or tube so that the same are not wasted. In a preferred embodiment of the present invention, the content extraction device is comprised of an elongated body portion and a plurality of head portions of varying shape and size that may be removably attached to one end of said elongated body portion and used to remove the remaining contents of a package, such as a tube, bottle or the like. In an alternative embodiment of the present invention, a head portion may be removably attached to each end of elongated body portion.

The content extraction device of the present invention enables a user to extract remaining product from a container so as to avoid having to discard useful product that could not otherwise be obtained from the container. The device also reduces the likelihood that the user will engage in inefficient and dangerous activities, such as attempting to cut open a container with scissors or a knife to extract the remaining product therefrom. Additionally, the interchangeability of the head portion enables a user to employ the device on various types of containers of varying shape, size and configuration without having to purchase additional devices. Further, if a particular head portion becomes worn, damaged or otherwise unusable, a user can simply detach the same and attach a new head portion. Finally, the content extraction device of the present invention is relatively inexpensive to manufacture and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of a preferred embodiment of the content extraction device of the present invention in a disassembled state.

FIG. 2 is a perspective view of a preferred embodiment of the content extraction device of the present invention in an assembled state.

FIG. 3 is a perspective view of a preferred embodiment of the content extraction device of the present invention being used to extract product from a relatively transparent bottle.

FIG. 4 is a perspective view of a preferred embodiment of the content extraction device of the present invention with extracted product on the head portion.

FIG. 5 is a perspective view of an alternative embodiment of the content extraction device of the present invention with a head portion attached to each end of the body portion.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

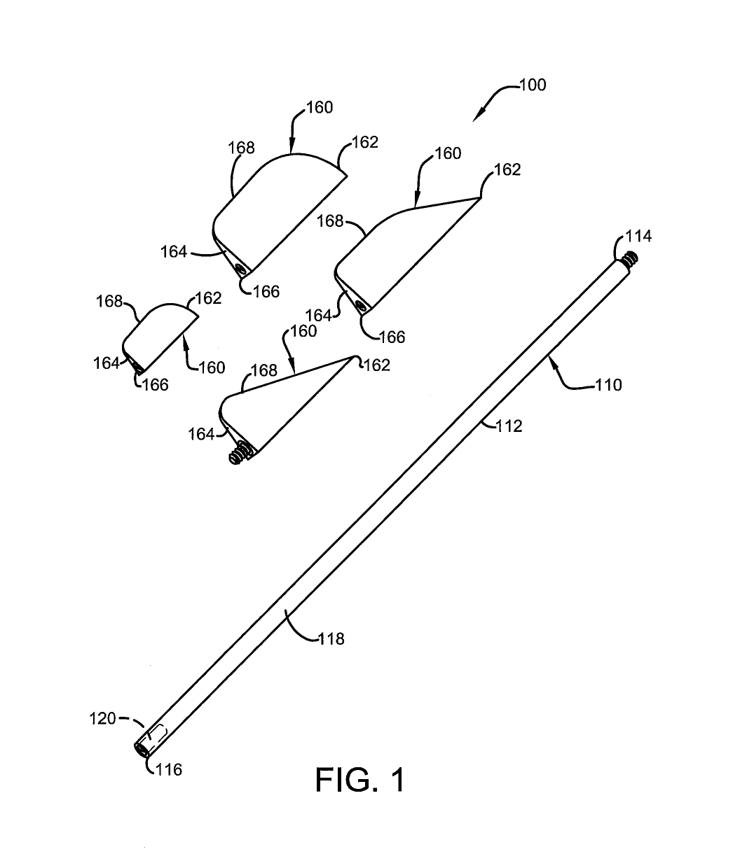

Referring initially to the drawings, FIG. 1 illustrates a perspective view of a preferred embodiment of the content extraction device 100 of the present invention in a disassembled state. Device 100 is preferably comprised of a body portion 110 and one or more interchangeable head portions 160 that may be removably attached to body portion 110, as described more fully below. Unless otherwise stated herein, body portion 110 and each of head portions 160 are preferably comprised of a generally flexible material such as plastic. Nonetheless, it is contemplated that other materials such as rubber, wood, metal or the like could also be used without impacting the overall scope of the invention.

Body portion 110 is preferably comprised of an elongated member 112, a first end 114, a second end 116, and an exterior surface 118. In a preferred embodiment of the present invention, elongated member 112 is generally cylindrically shaped for easy insertion into a container opening, as described more fully below. Elongated member 112 is preferably between ten and fourteen inches in length, as measured between first end 114 and second end 116, and between ⅛th and ⅜ths of an inch in diameter. Nonetheless, it is contemplated that other shapes and dimensions, colors and designs could also be used to suit user preference and/or a particular embodiment.

Exterior surface 118 may be relatively smooth or scored for easy gripping, particularly when body portion 110 comes into contact with the contents of the container or bottle being cleaned which could otherwise make it difficult for a user (not shown) to grip body portion 110. Additionally, either or both of said first and second ends 114, 116 may be threaded or contain an opening 120 therein for attaching said body portion 110 to one of interchangeable head portions 160, as described more fully below.

As best illustrated in FIG. 1, each of head portions 160 preferably comprise a top 162, a bottom 164, and a blade portion 168. The overall shape and dimensions of head portion 160 and blade portion 168 may vary to suit user preference and/or a particular application, but must be capable of fitting within an opening 210 in a container 200 to retrieve container contents 220, as described more fully below. For example, head portion 160 may have an overall length of between one and two inches, as measured between top 162 and bottom 164 with bottom 164 being removably attached to body portion 110, and an overall width of between ½ and one inch. Bottom 164 may further comprise a threaded portion or an opening 166 formed therein for removably attaching head portion 160 to body portion 110.

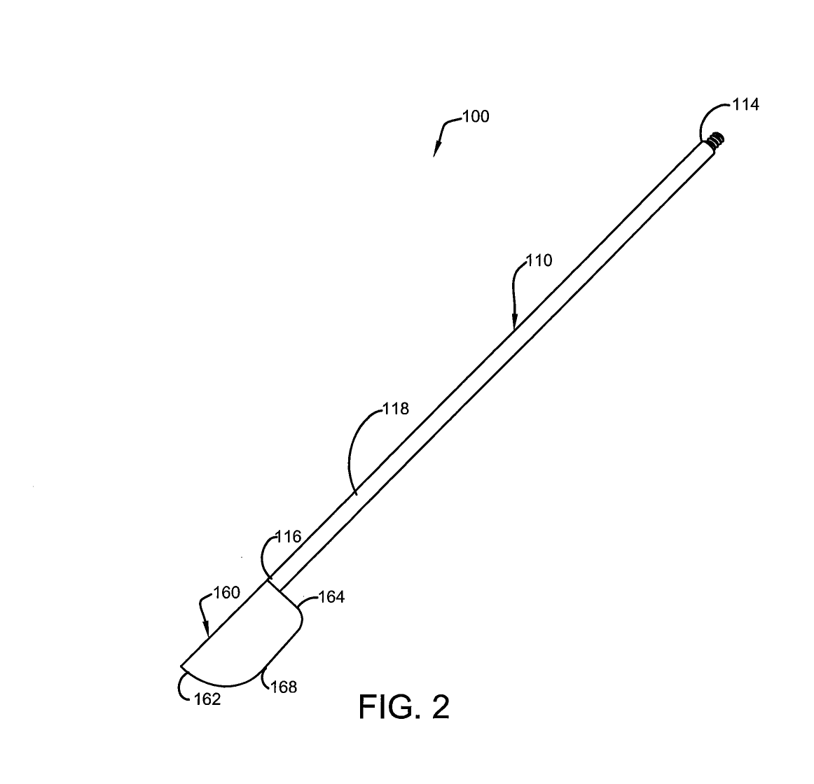

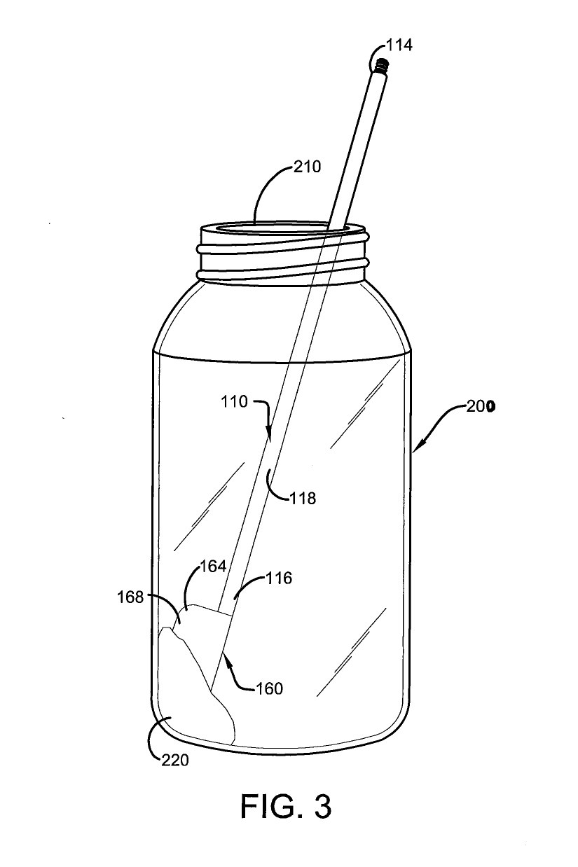

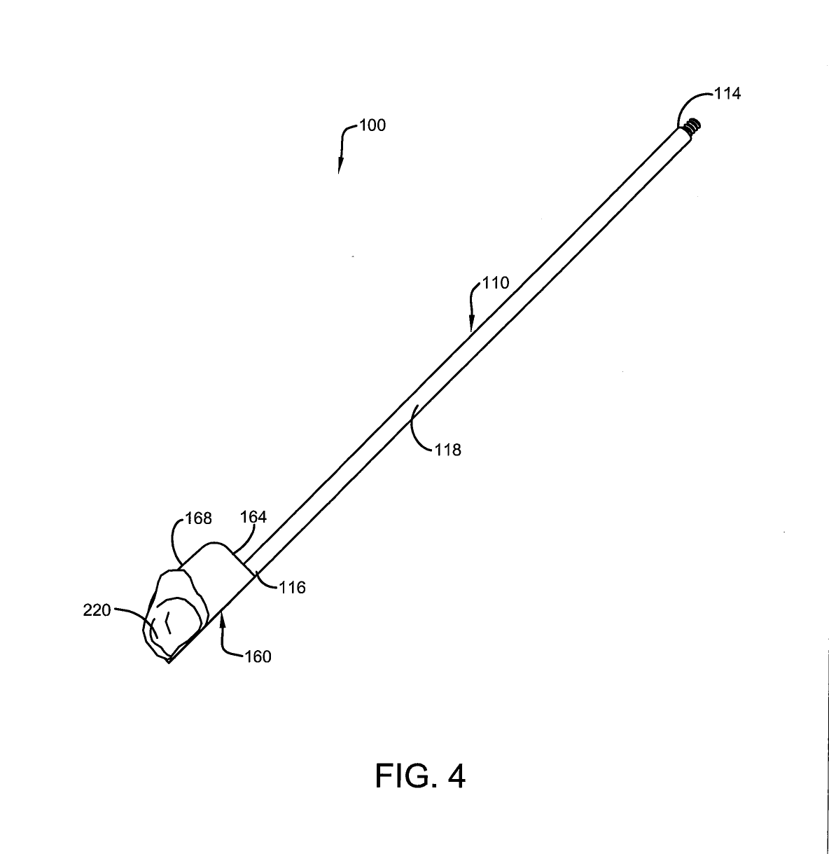

FIG. 2 illustrates a perspective view of a preferred embodiment of the content extraction device 100 of the present invention in an assembled state with a single head portion 160 attached to body portion 110. Having described the overall structure of content extraction device 100 of the present invention, ifs use and usefulness will now be described. A user (not shown) desiring to extract or empty the remaining contents 220 out of a container 200 will simply attach an appropriately shaped and sized head portion 160 to body portion 110 by any common means known in the art, such as threading first or second end 114, 116 of elongated member 112 into opening 166 in bottom 164. A head portion 160 is appropriately shaped and sized if it will pass through opening 210 in container 200 to access the interior space of the container and retrieve container contents 220. Once on the interior of container 200, the user (not shown) uses the blade 168 of head portion 160 to scrape the contents from the container 200 and extract the same through opening 210. FIG. 3 is a perspective view of a preferred embodiment of the content extraction device 100 of the present invention being used to extract the product contents 220 therefrom, and FIG. 4 is a perspective view of a preferred embodiment of the content extraction device 100 with extracted product contents 220 on the blade 168 of head portion 160 where it can be enjoyed by the user.

In this manner, a user (not shown) can utilize the device 100 to extract remaining product 220 from a container 200 so as to avoid having to discard useful product 220 that could not otherwise be obtained from a partially used container 200. Device 100 also reduces the likelihood that the user (not shown) will engage in inefficient and dangerous activities, such as attempting to cut a container 200 open with scissors or a knife to extract the remaining product 220 therefrom. Additionally, the relatively easy interchangeability of head portion 160 enables a user (not shown) to employ device 100 on containers 200 of varying shape, size and configuration without having to purchase additional devices 100. Further, if a particular head portion 160 or blade 168 becomes worn, damaged or otherwise unusable, a user (not shown) can simply detach the same and attach a new head portion 160 to body portion 110.

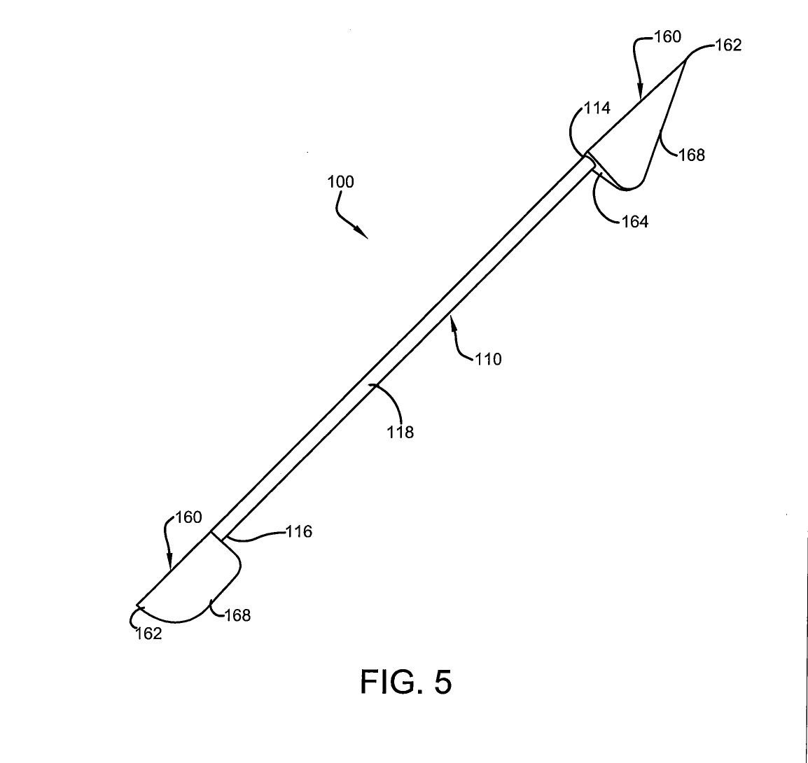

As a further advantage, FIG. 5 is a perspective view of an alternative embodiment of content extraction device 100 with a head portion 160 removably attached to each of first and second ends 114, 116 of elongated member 112 so that a user can extract product 220 from two different containers 200 without having to change head portion 160 or cross contaminate the containers 200. Finally, content extraction device 100 of the present invention is relatively inexpensive to manufacture and safe and easy to use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A content extraction device comprising:
a body portion; and
at least one head portion removably attached to said body portion.

2. The content extraction device of claim 1, wherein said body portion is further comprised of an elongated member having a first end and a second end, wherein said at least one head portion is removably attached to one of said first end or said second end.

3. The content extraction device of claim 1, wherein said body portion is further comprised of an elongated member having a first end and a second end, wherein a first head portion is attached to the first end, and a second head portion is attached to the second end.

4. The content extraction device of claim 2, wherein at least one of said first end and said second end is threaded.

5. The content extraction device of claim 2, wherein said elongated member is between 10 and 14 inches in length as measured between said first end and said second end.

6. The content extraction device of claim 2, wherein said elongated member is generally cylindrically shaped and comprises a diameter of between ⅛th and ⅜ths of an inch.

7. A content extraction device comprising:
a body portion; and
a first head portion attached to said body portion, wherein said first head portion further comprises a top, a bottom and a blade portion.

8. The content extraction device of claim 7, wherein said body portion is further comprised of an elongated member having a first end and a second end, wherein said first head portion is removably attached to one of said first end or said second end.

9. The content extraction device of claim 7, wherein said body portion is further comprised of an elongated member having a first end and a second end and said content extraction device is further comprised of a second head portion, wherein said first head portion is attached to the first end and the second head portion is attached to the second end.

10. The content extraction device of claim 8, wherein at least one of said first end and said second end is threaded.

11. The content extraction device of claim 8, wherein said elongated member is between 10 and 14 inches in length as measured between said first end and said second end.

12. The content extraction device of claim 8, wherein said elongated member is generally cylindrically shaped and comprises a diameter of between ⅛th and ⅜ths of an inch.

13. The content extraction device of claim 8, wherein said bottom is comprised of an opening for receipt of at least one of said first end and said second end.

14. The content extraction device of claim 8, wherein at least one of said first end and said second end further comprises an opening therein for receipt of said bottom.

15. A content extraction device comprising:
a body portion comprised of an elongated member having a first end and a second end; and
a first head portion comprised of a top, a bottom and a blade portion for insertion into an opening in a container, wherein said first head portion is removably attached to one of said first or second ends.

16. The content extraction device of claim 15 further comprised of a second head portion, wherein said first head portion is removably attached to the first end and the second head portion is removably attached to the second end.

17. The content extraction device of claim 15, wherein at least one of said first end and said second end is threaded.

18. The content extraction device of claim 15, wherein said elongated member is between 10 and 14 inches in length as measured between said first end and said second end, and comprises a diameter of between ⅛th and ⅜ths of an inch.

19. The content extraction device of claim 15, wherein said bottom is comprised of an opening for receipt of at least one of said first end and said second end.

20. The content extraction device of claim 15, wherein at least one of said first end and said second end further comprises an opening therein for receipt of said bottom.
